(19) United States
(12) Patent Application Publication
(10) Pub. No.: US 2023/0418090 A1
(43) Pub. Date: Dec. 28, 2023

(54) Polarization Control Device Based on Silicon Waveguide and Phase Change Material

(71) Applicant: SUN YAT-SEN UNIVERSITY, Guangzhou (CN)

(72) Inventors: Zhaohui Li, Guangzhou (CN); Yuhang Wei, Guangzhou (CN); Siqing Zeng, Guangzhou (CN); Yan Li, Guangzhou (CN); Ying Yu, Guangzhou (CN)

(21) Appl. No.: 18/130,065

(22) Filed: Apr. 3, 2023

(30) Foreign Application Priority Data
Jun. 28, 2022 (CN) 202210737959.8

(51) Int. Cl. G02F 1/01; G02B 27/28; G02B 27/10

(52) U.S. Cl. CPC G02F 1/0136; G02B 27/283; G02B 27/106; G02B 27/286; G02F 2202/10; G02F 2203/50; G02F 2202/16

(57) ABSTRACT

Provided is polarization control device based on silicon waveguide and phase change material, including polarization rotation beam splitter, optical beam splitter component, phase shifter component, and polarization rotation beam combiner; input end of polarization rotation beam splitter is connected to input optical fiber; input end of first optical beam splitter is connected to output end of polarization rotation beam splitter, first output end of first optical beam splitter is connected to first phase shifter, and second output end thereof is connected to second phase shifter; input end of second optical beam splitter is connected to first phase shifter and second phase shifter, respectively, first output end of second optical beam splitter is connected to third phase shifter, and second output end of second optical beam splitter is connected to fourth phase shifter; and input end of polarization rotation beam combiner is connected to third phase shifter and fourth phase shifter, respectively.

### CROSS-REFERENCE TO RELATED APPLICATION

The present disclosure claims the priority to a Chinese patent application with the filing No. 2022107379598 filed with the Chinese Patent Office on Jun. 28, 2022 and entitled “Polarization Control Device Based on Silicon Waveguide and Phase Change Material”, the contents of which are incorporated herein by reference in entirety.

### TECHNICAL FIELD

The present disclosure relates to the technical field of optical systems, in particular to a polarization control device based on silicon waveguide and phase change material.

### BACKGROUND

Nowadays, with the rapid development of Internet, Internet of Things, and HD video services, the total data flow of backbone network is rapidly increased by 40%-60% every year, and thus higher requirements are put forward for the communication system; over more than ten years of development, people are gradually aware that silicon-based optoelectronic integrated devices have become one of the key technologies for next generation of optical interconnection. However, with the increase of integration degree and the decrease of device dimension, the birefringence effect of silicon waveguide increasingly gets stronger, so that the response of the same silicon-based device to the signals of different polarization states is quite different. On the other hand, an optical signal is usually coupled into a chip by an edge coupler or a grating coupler for processing. As the optical fibers themselves are prone to deformation under the influence of external force, the polarization state of signal light transmitted in the optical fibers is also changed with it, they both cause the increasing loss brought about by polarization. At present, there are mainly two methods to reduce the influence of signal light travelling in silicon waveguide caused by polarization, one of which is to design a polarization-independent structure, for example, the cross section of a waveguide is designed into a symmetrical square shape, so that it has the same performance on any polarization state of input light. However, the most widely use way to obtain a silicon waveguide is by etching commercial silicon-on-insulator(SOI) wafer, whose silicon layer has a thickness of 220 nm. If the waveguide cross section is processed into a square shape, 220 nm width cannot support a single mode transmission of signal light, meanwhile, a completely symmetrical structure has strict requirements on fabrication process. The second way is to use a polarized light splitting and combining method, i.e., an input polarized light is firstly transformed into a light whose polarization state is supported by the silicon waveguide of current dimension. The two polarized signals are processed separately and then are combined and output with a reciprocal structure by virtue of a reversible optical path, which involves structures of on-chip polarization rotation, polarization beam splitting, and polarization beam combination.

Besides, the polarization modulation mainly involves two aspects of intensity modulation and phase modulation. In the silicon waveguide, Mach-Zehnder interferometer (MZI) structure is required for achieving intensity modulation, and a phase difference φ is introduced into two arms of MZI, so that optical signals of the two arms at the output of the MZI are coherent, the interference is constructive or destructive, and the output light intensity is changed along with phase shift tit. The phase modulation is more obvious, and the phase difference is directly introduced into both upper and lower paths of optical signals without involving an interference structure. Both of them require a phase shifter. A conventional silicon-based photonic platform can change the refractive index of silicon waveguide effective mode by means of thermo-optic effect or free carrier diffusion effect, and further realize optical phase shift. However, a thermo-optic phase shifter has low modulation rate and high power-consuming. The doped phase shifter based on free carrier diffusion can remarkably reduce the power consumption and improve the modulation rate to GHz level, but the change of the refractive index is relatively small, and the size is usually in millimeter level in a bid to realize π phase shift, which is not suitable for high-density integration.

### SUMMARY

A polarization control device based on silicon waveguide and phase change material, includes a polarization rotation beam splitter, an optical beam splitter component, a phase shifter component, and a polarization rotation beam combiner, wherein
an input end of the polarization rotation beam splitter is connected to an input optical fiber;
the optical beam splitter component includes a first optical beam splitter and a second optical beam splitter, the phase shifter component includes a first phase shifter, a second phase shifter, a third phase shifter, and a fourth phase shifter, the first phase shifter, the second phase shifter, the third phase shifter, and the fourth phase shifter are all optical phase shifters of silicon waveguide and phase change material, an input end of the first optical beam splitter is connected to an output end of the polarization rotation beam splitter, a first output end of the first optical beam splitter is connected to the first phase shifter, and a second output end of the first optical beam splitter is connected to the second phase shifter;
an input end of the second optical beam splitter is connected to the first phase shifter and the second phase shifter, respectively, a first output end of the second optical beam splitter is connected to the third phase shifter, and a second output end of the second optical beam splitter is connected to the fourth phase shifter; and
an input end of the polarization rotation beam combiner is connected to the third phase shifter and the fourth phase shifter, respectively.

### BRIEF DESCRIPTION OF DRAWINGS

In order to more clearly illustrate technical solutions of embodiments of the present disclosure, drawings that need to be used in the embodiments of the present disclosure will be described briefly below. It should be understood that the drawings below merely show some embodiments of the present disclosure, and therefore should not be considered as limitation to the scope. Those of ordinary skill in the art could also obtain other relevant drawings according to these drawings without using any inventive efforts.

FIG. 1 is a structural schematic diagram of a polarization control device based on silicon waveguide and phase change material provided in an embodiment of the present disclosure;

FIG. 2 is a structural schematic diagram of a polarization rotation beam splitter provided in an embodiment of the present disclosure;

FIG. 3 is a structural schematic diagram of an optical phase shifter provided in an embodiment of the present disclosure;

FIG. 4 is an electric field distribution map of a section of the optical phase shifter when a phase change material thin film is in an amorphous state provided in an embodiment of the present disclosure;

FIG. 5 is an electric field distribution map of a section of the optical phase shifter when the phase change material thin film is in a crystalline state provided in an embodiment of the present disclosure;

FIG. 6 is a diagram of influence of thickness change of the phase change material thin film on loss of the optical phase shifter provided in an embodiment of the present disclosure; and

FIG. 7 is a diagram of influence of thickness change of a conductive thin film on loss of the optical phase shifter provided in an embodiment of the present disclosure.

Reference signs: polarization rotation beam splitter 100; adiabatic tapered silicon waveguide 110; asymmetric directional coupler 120; multi-mode interference mode filter 130; upper output end mode transition cone 140; lower output end mode transition cone 150; optical beam splitter component 200; first optical beam splitter 210; second optical beam splitter 220; phase shifter component 300; silicon waveguide 301; phase change material thin film 302; conductive thin film 303; electrode 304; first phase shifter 310; second phase shifter 320; third phase shifter 330; fourth phase shifter 340; polarization rotation beam combiner 400.

### DETAILED DESCRIPTION OF EMBODIMENTS

Technical solutions in the embodiments of the present disclosure will be described below clearly and completely in combination with the drawings in the embodiments of the present disclosure, and apparently, the embodiments described are only some, but not all embodiments of the present disclosure. Generally, components in the embodiments of the present disclosure described and shown in the drawings herein may be arranged and designed in different configurations. Therefore, the detailed description below of the embodiments of the present disclosure provided in the drawings is not intended to limit the scope of protection of the present disclosure, but merely represents chosen embodiments of the present disclosure. Based on the embodiments of the present disclosure, all other embodiments obtained by a person skilled in the art without using any inventive efforts shall fall within the scope of protection of the present disclosure.

In the present disclosure, orientation or positional relationships indicated by terms such as “upper”, “lower”, “left”, “right”, “front”, “rear”, “top”, “bottom”, “inner”, “outer”, “middle”, “vertical”, “horizontal”, “transverse”, and “longitudinal” are based on orientation or positional relationships as shown in the drawings. These terms are mainly used to better describe the present disclosure and embodiments thereof, and are not used to limit that the indicated device, element, or component must be in a specific orientation, or be constructed and operated in a specific orientation.

Moreover, some of the above terms may be used to indicate other meanings in addition to being used to indicate the orientation or positional relationships, for example, the term “upper” may also be used to indicate a certain attachment relationship or connection relationship in some cases. For those ordinarily skilled in the art, specific meanings of these terms in the present disclosure could be understood according to specific circumstances.

Besides, terms “install”, “set”, “provide”, “connect”, and “join” should be understood in a broad sense. For example, it may be a fixed connection, a detachable connection, or an integral construction; it may be a mechanical connection, or a point connection; it may be a direct connection, an indirect connection through an intermediary, or inner communication between two devices, elements or components. For those ordinarily skilled in the art, specific meanings of the above-mentioned terms in the present disclosure could be understood according to specific circumstances.

Besides, terms such as “first” and “second” are mainly used to distinguish different devices, elements or components (specific types and constructions may be the same or different), rather than indicating or implying the relative importance or quantity of indicated device, element or component. “Multiple (a plurality of)” means two or more, unless otherwise indicated.

Objectives of embodiments of the present disclosure include, for example, providing a polarization control device based on silicon waveguide and phase change material, which can realize the technical effect of generating input-independent arbitrarily polarized light based on the silicon waveguide.

An embodiment of the present disclosure provides a polarization control device based on silicon waveguide and phase change material, including a polarization rotation beam splitter, an optical beam splitter component, a phase shifter component, and a polarization rotation beam combiner, wherein an input end of the polarization rotation beam splitter is connected to an input optical fiber;
the optical beam splitter component includes a first optical beam splitter and a second optical beam splitter, the phase shifter component includes a first phase shifter, a second phase shifter, a third phase shifter, and a fourth phase shifter, the first phase shifter, the second phase shifter, the third phase shifter, and the fourth phase shifter are all optical phase shifters of silicon waveguide and phase change material, an input end of the first optical beam splitter is connected to an output end of the polarization rotation beam splitter, a first output end of the first optical beam splitter is connected to the first phase shifter, and a second output end of the first optical beam splitter is connected to the second phase shifter;
an input end of the second optical beam splitter is connected to the first phase shifter and the second phase shifter, respectively, a first output end of the second optical beam splitter is connected to the third phase shifter, and a second output end of the second optical beam splitter is connected to the fourth phase shifter; and an input end of the polarization rotation beam combiner is connected to the third phase shifter and the fourth phase shifter, respectively.

In the above implementation process, in the polarization control device, an optical signal input from an input optical fiber is processed by the polarization rotation beam splitter, the first optical beam splitter, the first phase shifter, the second phase shifter, the second optical beam splitter, the third phase shifter, the fourth phase shifter, and the polarization rotation beam combiner in sequence, and the first phase shifter, the second phase shifter, the third phase shifter, and the fourth phase shifter are all optical phase shifters of the silicon waveguide and phase change material, so that modulation of any input-independent silicon-waveguide-based polarization state is realized, and any polarization state can be generated on premise of small dimension and low loss, wherein the optical phase shifters of the silicon waveguide and phase change material can greatly reduce the dimension of the polarization control device, which is conducive to large-scale integration. Therefore, the polarization control device based on the silicon waveguide and phase change material can realize the technical effect of generating input-independent arbitrarily polarized light.

In one or more embodiments, the input optical fiber transmits two beams of orthogonally polarized optical signals, the polarization rotation beam splitter converts the two beams of optical signals in the input optical fiber into two beams of optical signals in the preset mode, the two beams of optical signals in the preset mode are respectively transmitted to the input end of the first optical beam splitter, and the two beams of optical signals in the preset mode have the same intensity and the same phase.

In one or more embodiments, the first optical beam splitter combines the two beams of optical signals in the preset mode, and outputs the combined optical signals respectively from the first output end and the second output end of the first optical beam splitter according to the equally divided power.

In the above implementation process, the first optical beam splitter interferes with and combines the input optical signals of two paths in the preset mode, keeps the polarization state unchanged, and outputs the combined optical signals from upper and lower paths according to power of 50:50, wherein the optical signals of two paths output are the same.

In one or more embodiments, the second optical beam splitter combines the optical signal transmitted by the first phase shifter and the optical signal transmitted by the second phase shifter, and outputs the combined optical signals respectively from the first output end and the second output end of the second optical beam splitter according to the equally divided power.

In one or more embodiments, the first optical beam splitter is a multi-mode interference coupler or a directional coupler, and the second optical beam splitter has the same structure as the first optical beam splitter.

In one or more embodiments, the optical phase shifter has a silicon waveguide, a phase change material thin film with a width equal to that of the silicon waveguide, and a conductive thin film in sequence from bottom to top, an electrode is arranged at each of two sides of the optical phase shifter, and an electrical path is formed between the electrode and the conductive thin film.

In the above implementation process, the phase change material thin film and the silicon waveguide are of equal width, and the conductive thin film grown on an upper layer and the electrodes at two sides form a miniature heater, and the heat is conducted to the phase change material thin film, so that the phase change material on the phase change material thin film is switched between an amorphous state and a crystalline state, so that the refractive index of the phase change material thin film is changed.

In one or more embodiments, the polarization rotation beam splitter is either a single integrated device or a cascading device, and the cascading device includes a silicon-based polarization beam combiner and a silicon-based polarization rotator.

In one or more embodiments, the polarization rotation beam combiner is either the single integrated device or the cascading device.

In one or more embodiments, the polarization rotation beam combiner and the polarization rotation beam splitter are in a centrosymmetric structure.

In the above implementation process, the polarization rotation beam splitter and the polarization rotation beam combiner are centrosymmetric, so that light of two paths having undergone intensity modulation and phase modulation is combined and output by the polarization rotation beam combiner.

In one or more embodiments, the optical beam splitter component is a 2×2 optical beam splitter component.

In one or more embodiments, the first phase shifter is a phase shifter of phase change material, the optical signal is phase-shifted by θ degrees through an external electric pulse; and the second phase shifter, having the same structure as the first phase shifter, does not perform phase modulation, so as to eliminate phase difference generated by the phase shifter itself.

In one or more embodiments, the third phase shifter and the fourth phase shifter have the same structure as the first phase shifter, wherein the third phase shifter phase-shifts the optical signal by φ through an external electrical pulse; and no external voltage is applied to electrodes of the fourth phase shifter, and no additional phase shift is generated except for change of optical path difference caused by the fourth phase shifter itself.

In one or more embodiments, the polarization rotation beam combiner first rotates light passing through the fourth phase shifter, then combines the rotated light with light passing through the third phase shifter, and outputs the combined light.

In one or more embodiments, the optical beam splitter component and the phase shifter component are both TE₀ single-mode-transmission waveguide.

In one or more embodiments, the polarization rotation beam splitter includes an adiabatic tapered silicon waveguide, an asymmetric directional coupler, a multi-mode interference mode filter, an upper output end mode transition cone, and a lower output end mode transition cone.

In one or more embodiments, the optical phase shifter has a silicon waveguide, a phase change material thin film with a width equal to that of the silicon waveguide, and a conductive thin film in sequence from bottom to top, an electrode is arranged at each of two sides of the optical phase shifter, and an electrical path is formed between the electrode and the conductive thin film.

In one or more embodiments, the electrodes are gold electrodes; the conductive thin film is an indium tin oxide thin film or a graphene thin film; and the phase change material thin film is a Sb₂Se₃ thin film.

In one or more embodiments, the polarization rotation beam combiner and the polarization rotation beam splitter are in a centrosymmetric structure.

In one or more embodiments, the phase change material is one selected from the group consisting of Sb₂S₃, Ge₂Sb₂Te₆, Sb₂Se₃, and Ge₂Sb₂Se₄Te₆.

In one or more embodiments, the phase shifter component is an optical phase shifter with the phase change material thin film being Sb₂S₃ and the conductive thin film being the indium tin oxide thin film.

The beneficial effects of the embodiments of the present disclosure are as follows.

The embodiments of the present disclosure disclose a polarization control device, in the polarization control device, the optical signal input from the input optical fiber is processed by the polarization rotation beam splitter, the first optical beam splitter, the first phase shifter, the second phase shifter, the second optical beam splitter, the third phase shifter, the fourth phase shifter, and the polarization rotation beam combiner in sequence, and the first phase shifter, the second phase shifter, the third phase shifter, and the fourth phase shifter are all optical phase shifters of the silicon waveguide and phase change material, so that modulation of any input-independent silicon-waveguide-based polarization state is realized, and any polarization state can be generated on premise of small dimension and low loss, wherein the optical phase shifters of the silicon waveguide and phase change material can greatly reduce the dimension of the polarization control device, which is conducive to large-scale integration. Therefore, the polarization control device based on the silicon waveguide and phase change material can realize the technical effect of generating input-independent arbitrarily polarized light.

Besides, the polarization control device based on silicon waveguide and phase change material provided in the embodiments of the present disclosure is a polarization control device on the silicon substrate, and has at least the following beneficial effects: (1) being capable of realizing the generation of any on-chip polarization state independent of the optical signal input; and (2) being compatible with the conventional CMOS processing technology, having a simple and compact structure, further reducing the dimension of the devices by virtue of the high refractive index of the silicon waveguide and the high refractive index change of the phase change material thin film in the crystalline state-amorphous state, and being suitable for large-scale integration.

Other features and advantages of the present disclosure will be illustrated in subsequent description, or some features and advantages may be deduced or undoubtedly determined from the description, or obtained by implementing the above technologies disclosed in the present disclosure.

In order to make the above objectives, features, and advantages of the present disclosure more apparent and easily understood, detailed description is made below by way of preferred embodiments hereinafter in combination with the drawings.

Objectives of embodiments of the present disclosure include, for example, providing a polarization control device based on silicon waveguide and phase change material, which can be applied to a polarization modulation process of an optical signal. In the polarization control device, an optical signal input from an input optical fiber is processed by a polarization rotation beam splitter, a first optical beam splitter, a first phase shifter, a second phase shifter, a second optical beam splitter, a third phase shifter, a fourth phase shifter, and a polarization rotation beam combiner in sequence, and the first phase shifter, the second phase shifter, the third phase shifter, and the fourth phase shifter are all optical phase shifters of the silicon waveguide and phase change material, so that modulation of any input-independent silicon-waveguide-based polarization state is realized, and any polarization state can be generated on premise of small dimension and low loss, wherein the optical phase shifters of the silicon waveguide and phase change material can greatly reduce the dimension of the polarization control device, which is conducive to large-scale integration. Therefore, the polarization control device based on the silicon waveguide and phase change material can realize the technical effect of generating input-independent arbitrary polarization light.

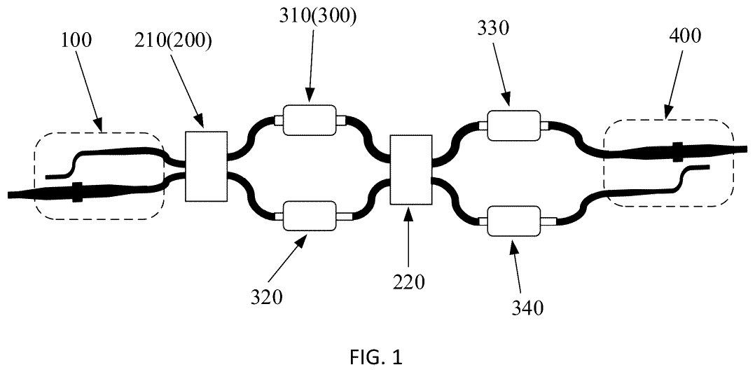

Referring to FIG. 1, FIG. 1 is a structural schematic diagram of a polarization control device based on silicon waveguide and phase change material provided in an embodiment of the present disclosure, wherein the polarization control device based on silicon waveguide and phase change material includes a polarization rotation beam splitter 100, an optical beam splitter component 200, a phase shifter component 300, and a polarization rotation beam combiner 400.

In one or more embodiments, an input end of the polarization rotation beam splitter 100 is connected to an input optical fiber.

In one or more embodiments, the input optical fiber transmits therein two beams of orthogonally polarized optical signals to the polarization rotation beam splitter 100; and optionally, the polarization rotation beam splitter 100 converts the two beams of orthogonally polarized optical signals in the input optical fiber into TE₀ mode with the same phase and the same intensity.

In one or more embodiments, the optical beam splitter component 200 includes a first optical beam splitter 210 and a second optical beam splitter 220. The phase shifter component 300 includes a first phase shifter 310, a second phase shifter 320, a third phase shifter 330, and a fourth phase shifter 340, wherein the first phase shifter 310, the second phase shifter 320, the third phase shifter 330, and the fourth phase shifter 340 are all optical phase shifters of silicon waveguide and phase change material. An input end of the first optical beam splitter 210 is connected to an output end of the polarization rotation beam splitter 100, a first output end of the first optical beam splitter 210 is connected to the first phase shifter 310, and a second output end of the first optical beam splitter 210 is connected to the second phase shifter 320.

In one or more embodiments, an input end of the second optical beam splitter 220 is connected to the first phase shifter 310 and the second phase shifter 320, respectively, a first output end of the second optical beam splitter 220 is connected to the third phase shifter 330, and a second output end of the second optical beam splitter 220 is connected to the fourth phase shifter 340.

In one or more embodiments, the first optical beam splitter 210 combines the two beams of optical signals of the polarization rotation beam splitter 100 and then equally divides the power, that is, outputs the combined optical signals from the two output ends (the first output end and the second output end) of the first optical beam splitter 210 according to power of 50:50, wherein the optical signal of one path passes through the first phase shifter 310, and the optical signal of the other path passes through the second phase shifter 320.

In one or more embodiments, the first phase shifter 310, which is a phase shifter of phase change material, phase-shifts the optical signal of this path by θ degrees through an external electric pulse; and the second phase shifter 320, having the same structure as the first phase shifter 310, does not perform phase modulation, so as to eliminate phase difference generated by the phase shifter itself.

In one or more embodiments, the second optical beam splitter 220 combines the optical signals of two paths having being phase-shifted by the first phase shifter 310 and the second phase shifter 320, and then equally divides the power, that is, splits the combined optical signals according to power of 50: 50. The third phase shifter 330 and the fourth phase shifter 340 have the same structure as the first phase shifter 310, and for the optical signals of two paths output by the second optical beam splitter 220, one path generates φ phase shift through the third phase shifter 330 under the effect of an external electrical pulse, and the other path passes through the fourth phase shifter 340 and does not generate additional phase shift as no electrical pulse is applied.

In one or more embodiments, an input end of the polarization rotation beam combiner 400 is connected to the third phase shifter 330 and the fourth phase shifter 340, respectively.

In one or more embodiments, the polarization rotation beam combiner 400 first rotates light passing through the fourth phase shifter 340, then combines the rotated light with light passing through the third phase shifter 330, and outputs the combined light. In the above manner, modulation of any input-independent silicon-waveguide-based polarization state is realized.

In some embodiments, except for the polarization rotation beam splitter 100 and the polarization rotation beam combiner 400, all of other structures (the optical beam splitter component 200 and the phase shifter component 300) are TE₀ single-mode-transmission waveguide.

In some embodiments, in the polarization control device, the optical signal input from the input optical fiber is processed by the polarization rotation beam splitter 100, the first optical beam splitter 210, the first phase shifter 310, the second phase shifter 320, the second optical beam splitter 220, the third phase shifter 330, the fourth phase shifter 340, and the polarization rotation beam combiner 400 in sequence, and the first phase shifter 310, the second phase shifter 320, the third phase shifter 330, and the fourth phase shifter 340 are all optical phase shifters of the silicon waveguide and phase change material, so that modulation of any input-independent silicon-waveguide-based polarization state is realized. The optical phase shifters of the silicon waveguide and phase change material can greatly reduce the dimension of the polarization control device, which is conducive to large-scale integration; thus, the polarization control device based on the silicon waveguide and phase change material can realize the technical effect of generating input-independent arbitrary polarization light.

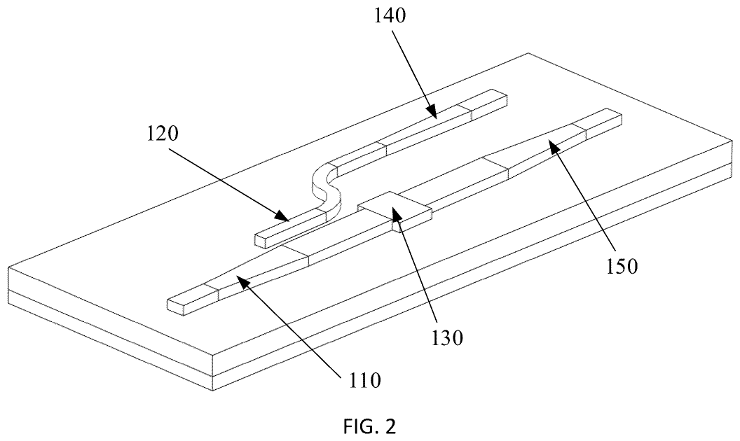

Referring to FIG. 2, FIG. 2 is a structural schematic diagram of a polarization rotation beam splitter provided in an embodiment of the present disclosure.

In one or more embodiments, the polarization rotation beam splitter 100 in the embodiments of the present disclosure includes an adiabatic tapered silicon waveguide 110, an asymmetric directional coupler 120, a multi-mode interference mode filter 130, an upper output end mode transition cone 140, and a lower output end mode transition cone 150. Optionally, an input end of the polarization rotation beam splitter 100 has a width of 500 nm and a height of 220 nm, and is a single-mode-transmission silicon waveguide. The adiabatic tapered silicon waveguide 110 ensures stable transmission of the TE₀ mode, and the TM₀ mode evolves into a TE₁ mode. The asymmetric directional coupler 120 makes the TE₀ mode continue to transmit along lower waveguide without coupling, the TE₁ mode is subjected to coupling into upper waveguide, and meanwhile, the mode is converted into the TE₀ mode to transmit along the upper waveguide. The multi-mode interference mode filter 130 mainly makes the TE₀ mode pass through with a lower loss, while the uncoupled TE₁ mode is truncated here with a relatively high extinction ratio. The upper output end mode transition cone 140 and the lower output end mode transition cone 150 are configured to match the waveguide dimension at the output end of the polarization rotation beam splitter 100 with the waveguide dimension at an input end of subsequent components.

In one or more embodiments, a preset mode in the embodiments of the present disclosure can be TM₀ mode.

In one or more embodiments, the input optical fiber transmits two beams of orthogonally polarized optical signals, the polarization rotation beam splitter 100 converts the two beams of optical signals in the input optical fiber into two beams of optical signals in the preset mode, the two beams of optical signals in the preset mode are respectively transmitted to the input end of the first optical beam splitter 210, and the two beams of optical signals in the preset mode have the same intensity and the same phase.

In one or more embodiments, the first optical beam splitter 210 combines the two beams of optical signals in the preset mode, and outputs the combined optical signals respectively from the first output end and the second output end of the first optical beam splitter 210 according to the equally divided power.

In one or more embodiments, the first optical beam splitter 210 interferes with and combines the input optical signals of two paths in the preset mode, keeps the polarization state unchanged, and outputs the combined optical signals from upper and lower paths according to power of 50:50, wherein the optical signals of two paths output are the same.

In one or more embodiments, the second optical beam splitter 220 combines the optical signal transmitted by the first phase shifter 310 and the optical signal transmitted by the second phase shifter 320, and outputs the combined optical signals respectively from the first output end and the second output end of the second optical beam splitter 220 according to the equally divided power.

In one or more embodiments, the first optical beam splitter is a multi-mode interference coupler or a directional coupler, and the second optical beam splitter has the same structure as the first optical beam splitter.

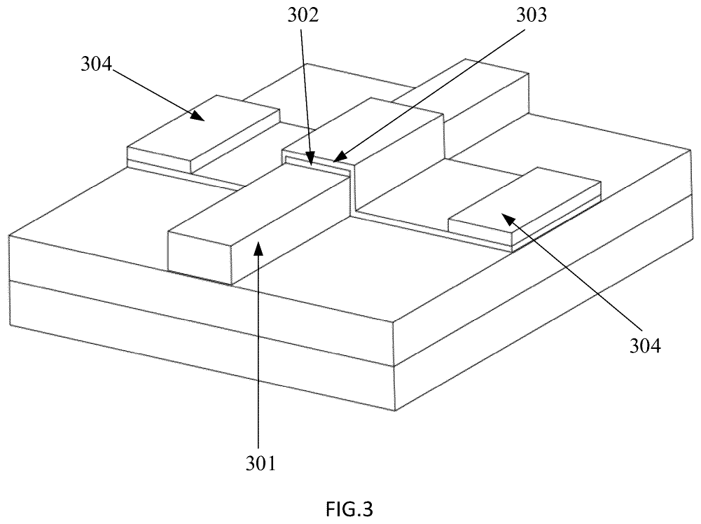

Referring to FIG. 3, FIG. 3 is a structural schematic diagram of the optical phase shifter provided in an embodiment of the present disclosure.

In one or more embodiments, the optical phase shifter has a silicon waveguide 301, a phase change material thin film 302 with a width equal to that of the silicon waveguide 301, and a conductive thin film 303 in sequence from bottom to top, an electrode 304 is arranged at each of two sides of the optical phase shifter, and an electrical path is formed between the electrodes 304 and the conductive thin film 303.

In some embodiments, the electrodes 304 are gold electrodes; the conductive thin film 303 can be an indium tin oxide thin film or a graphene thin film; and the phase change material thin film 302 may be a Sb₂Se₃ thin film.

In one or more embodiments, the phase change material thin film 302 and the silicon waveguide 301 are of equal width, and the conductive thin film 303 grown on an upper layer and the electrodes 304 at two sides form a miniature heater, and the heat is conducted to the phase change material thin film 302, so that the phase change material on the phase change material thin film 302 is switched between an amorphous state and a crystalline state, so that the refractive index of the phase change material thin film 302 is changed.

In one or more embodiments, the polarization rotation beam splitter 100 is one of a single integrated device and a cascading device, and the cascading device includes a silicon-based polarization beam combiner and a silicon-based polarization rotator.

In one or more embodiments, the polarization rotation beam combiner 400 is one of a single integrated device and a cascading device.

In one or more embodiments, the polarization rotation beam combiner 400 and the polarization rotation beam splitter 100 are in a centrosymmetric structure.

In one or more embodiments, the polarization rotation beam splitter 100 and the polarization rotation beam combiner 400 are centrosymmetric, so that light of two paths having undergone intensity modulation and phase modulation is combined and output by the polarization rotation beam combiner 400.

Optionally, the optical signal in the TE₀ mode passing through the third phase shifter 330 is directly output, and the optical signal in the TE₀ mode passing through the fourth phase shifter 340 is first rotated into the TM₀ mode and then combined and output.

In one or more embodiments, the optical beam splitter component 200 is a 2×2 optical beam splitter component.

In one or more embodiments, the phase shifter component 300 is an optical phase shifter of silicon waveguide and phase change material, wherein a phase change material thin film 302 of the optical phase shifter may be a Sb₂S₃ phase change material thin film. Due to its characteristic of a relatively large difference between real parts and a relatively small difference between imaginary parts of the crystalline state-amorphous state refractive index, it can be applied to a silicon-based photonic platform to process small-sized and low-loss functional devices.

In one or more embodiments, according to an electrical pulse signal received by the electrodes 304, subject to Joule's law, as the conductive thin film 303 (indium tin oxide or graphene material) itself has a certain electrical conductivity, a current flows through the conductive thin film 303 to generate heat and the heat is conducted to the phase change material thin film 302, so that the phase change material on the phase change material thin film 302 is switched between the amorphous state and the crystalline state, so as to make the refractive index of the phase change material thin film 302 changed. Specifically, for the phase change material thin film 302, the triggering from the amorphous state to the crystalline state needs to be cumulatively excited by a plurality of low-voltage long pulses about 3 V, to make the temperature thereof reach a crystallization temperature, while the transition from the crystalline state to the amorphous state requires only one relatively-high-voltage (6˜10 V) short pulse to raise the temperature thereof to a melting temperature and then anneal rapidly. In both processes, the pulse width is on the order of nanoseconds. The phase change material thin film 302 will be in any one of the crystalline state, the amorphous state or an intermediate state by controlling the electrical pulse voltage and the pulse width, thus, the refractive index can be controlled to change continuously. The optical signal output from the first output end of the first optical beam splitter 210 can achieve the phase shift of θ (θ≤θ≤2π) through the first phase shifter 310, and then enters the second optical beam splitter 220.

In one or more embodiments, the second phase shifter 320 and the first phase shifter 310 are of the same structure, and the electrodes 304 of the second phase shifter 320 are not externally connected to a voltage source. Therefore, after the optical signal output by the second output end of the first optical beam splitter 210 passes through the second phase shifter 320, and then enters the second optical beam splitter 220, without additional phase shift except for the change of optical path difference brought by the phase shifter itself.

In one or more embodiments, the second optical beam splitter 220 is of the same structure as the first optical beam splitter 210, and functions to combine the optical signals of two paths of the first phase shifter 310 and the second phase shifter 320 and then output the combined optical signals according to power of 50:50, and keep the polarization state unchanged. As the optical signals of two paths have undergone the phase shift processing when passing through the first phase shifter 310 and the second phase shifter 320 and they have the phase difference of θ therebetween, interference occurs in the beam combining process of the second optical beam splitter 220, the interference is constructive or destructive, and the light intensity changes. Therefore, the first optical beam splitter 210, the first phase shifter 310, the second phase shifter 320, and the second optical beam splitter 220 actually form an intensity modulator.

In one or more embodiments, the third phase shifter 330 is of the same structure as the first phase shifter 310. The optical signal output from the first output end of the second optical beam splitter 220, when passing through the third phase shifter 330, realizes phase shift of φ (θ≤φ≤2π) under the control of an externally applied electrical pulse, and then enters the polarization rotation beam combiner 400.

In one or more embodiments, the fourth phase shifter 340 is of the same structure as the first phase shifter 310, no external voltage is applied to the electrodes of the fourth phase shifter 340, no additional phase shift is generated except for the change of optical path difference caused by the fourth phase shifter 340 itself, and then the optical signal enters the polarization rotation beam combiner 400.

In one or more embodiments, the polarization rotation beam combiner 400 and the polarization rotation beam splitter 100 are of a centrosymmetric structure. The polarization rotation beam combiner 400 functions to combine and output the optical signals of two paths having undergone intensity modulation and phase modulation. Optionally, the optical signal in the TE₀ mode passing through the third phase shifter 330 is directly output, and the optical signal in the TE₀ mode passing through the fourth phase shifter is first rotated into the TM₀ mode and then combined and output.

Optionally, in the above solutions, in the structure of the phase shifter component, the phase change material may be one of Sb₂S₃, Ge₂Sb₂Te₆, Sb₂Se₃, and Ge₂Sb₂Se₄Te₆.

Exemplarily, if optical electric fields of two paths of the same phase and the same intensity after passing through the polarization rotation beam splitter 100 are E₁, a total phase difference generated by the optical signals of two paths passing through the first phase shifter 310 and the second phase shifter 320 is θ, a total phase drift generated by light of two paths passing through the third phase shifter 330 and the fourth phase shifter 340 is φ, light input into the polarization rotation beam combiner is Eix, and output light of two ports after MZI interference is Eox and Eoy, then

$$\begin{matrix}[ \begin{matrix}{E}_{ox} \\ {E}_{oy}\end{matrix} ] = [ \begin{matrix}{e}^{j φ} & 0 \\ 0 & 1\end{matrix} ] \cdot \frac{1}{\sqrt{2}} [ \begin{matrix}1 & j \\ j & 1\end{matrix} ] [ \begin{matrix}{e}^{j θ} & 0 \\ 0 & 1\end{matrix} ] \frac{1}{\sqrt{2}} [ \begin{matrix}1 & j \\ j & 1\end{matrix} ] \cdot [ \begin{matrix}{E}_{ix} \\ 0\end{matrix} ] \\ = [ \begin{matrix}{e}^{j φ} & 0 \\ 0 & 1\end{matrix} ] \cdot {je}^{j \frac{θ}{2}} [ \begin{matrix}sin \frac{θ}{2} & cos \frac{θ}{2} \\ cos \frac{θ}{2} & - sin \frac{θ}{2}\end{matrix} ] \cdot [ \begin{matrix}{E}_{ix} \\ 0\end{matrix} ] \\ = {je}^{j \frac{θ}{2}} \cdot {E}_{ix} [ \begin{matrix}{e}^{j φ} sin \frac{θ}{2} \\ cos \frac{θ}{2}\end{matrix} ] ,\end{matrix} ;$$

where

$$\frac{1}{\sqrt{2}} [ \begin{matrix}1 & j \\ j & 1\end{matrix} ]$$

is a Jones matrix corresponding to the optical beam splitter component 200,

$$[ \begin{matrix}{e}^{j θ} & 0 \\ 0 & 1\end{matrix} ]$$

is a Jones matrix formed by the first phase shifter 310 and the second phase shifter 320, and

$$[ \begin{matrix}{e}^{j φ} & 0 \\ 0 & 1\end{matrix} ]$$

is a Jones matrix formed by the third phase shifter 330 and the fourth phase shifter 340.

It can be further obtained that:

$${E}_{ox} = {e}^{j φ} {E}_{ix} sin \frac{θ}{2} ; \\ {E}_{oy} = {E}_{ix} cos \frac{θ}{2} ;$$

they can be expressed by Stokes vector as:

S₀=EₒₓE*ₒₓ+E_{oy}E*_{oy}=Eᵢₓ²;

S₁=EₒₓE*ₒₓ−E_{oy}E*_{oy}=−Eᵢₓ² cos θ;

S₂=EₒₓE*_{oy}+E_{oy}E*ₒₓ=Eᵢₓ² sin θ cos φ;

S₃=j(EₒₓE*_{oy}−E_{oy}E*ₒₓ)=−Eᵢₓ² sin θ sin φ;

i.e.,

(S₀S₁S₂S₃)=(1−cos θ sin θ cos φ−sin θ sin φ);

which satisfies:

S₀²=S₁²+S₂²+S₃².

Therefore, the structure of the above solutions can cover a whole spherical surface on a Poincare sphere, i.e., the generation of any input-independent on-chip polarization state can be realized.

In some embodiments, the phase shifter component is an optical phase shifter with the phase change material thin film 302 being Sb₂S₃ and the conductive thin film 303 being the indium tin oxide thin film. Subject to Joule's law, as the conductivity of the indium tin oxide material itself is 2×10⁵ s m⁻¹, heat generated by the current flowing through an indium tin oxide cover layer is conducted to the Sb₂S₃ thin film, so that Sb₂S₃ is switched between the amorphous state and the crystalline state. Correspondingly, the refractive index is changed. Specifically, for the Sb₂S₃ material, the triggering from the amorphous state to the crystalline state needs to be cumulatively excited by raising the temperature thereof to 600 K with a plurality of low-voltage (about 3 V) long pulses, while the transition from the crystalline state to the amorphous state requires only one relatively-high-voltage (6˜10 V) short pulse to raise the temperature thereof to 800 K and then anneal rapidly. In the two processes, the pulse width is both on the order of nanoseconds. By controlling the electrical pulse voltage and the pulse width, the Sb₂S₃ thin film will be in any one of the crystalline state, the amorphous state or an intermediate state, thus, the refractive index can be controlled to change continuously. The light output from the upper path of the first optical beam splitter 210 can achieve the phase shift of θ (θ≤θ≤2π) through this phase shifter, and then enters the second optical beam splitter 220.

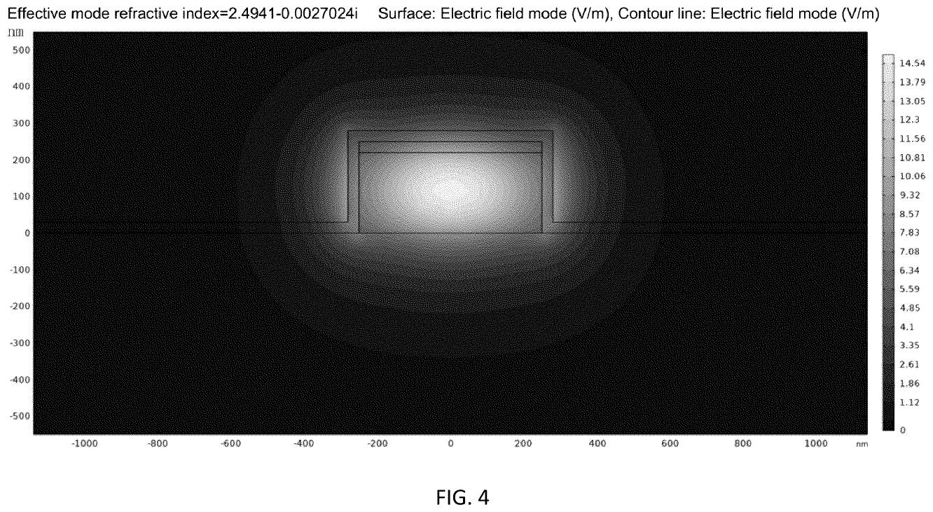

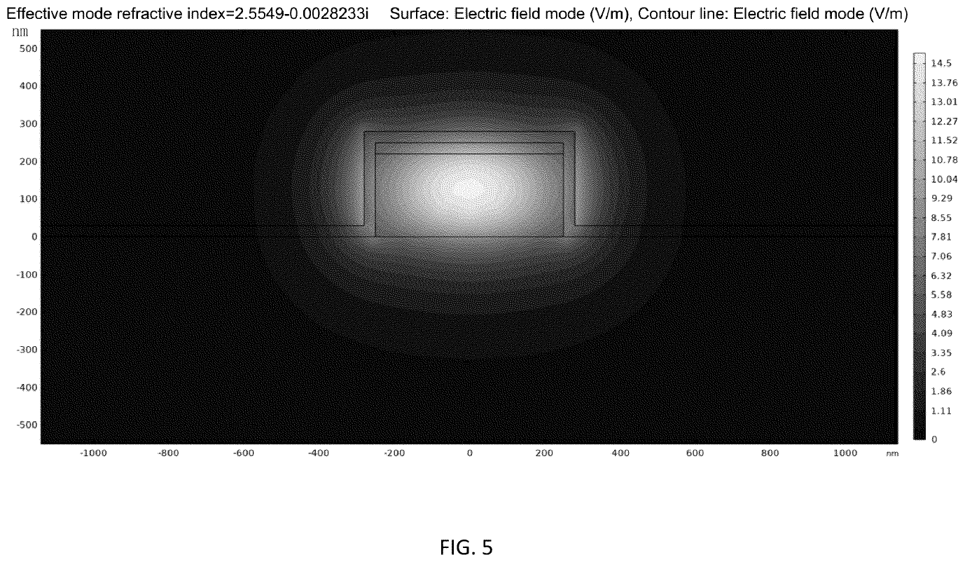

Referring to FIG. 4 and FIG. 5, FIG. 4 is an electric field distribution map of a section of the optical phase shifter when the phase change material thin film is in the amorphous state provided in an embodiment of the present disclosure; and FIG. 5 is an electric field distribution map of a section of the optical phase shifter when the phase change material thin film is in the crystalline state provided in an embodiment of the present disclosure. Optionally, the phase change material thin films in FIG. 4 and FIG. 5 are Sb₂Se₃ thin films.

In some implementation scenarios, the electric field distributions in which the phase change material thin film 302 (Sb₂Se₃ thin film) in the phase shifter component 300 is in the amorphous and crystalline states are as shown in FIG. 4 and FIG. 5, with an effective mode refractive index difference of 0.06, which, firstly, means that this structure can form a good path in the silicon waveguide 301, and the signal transmission process will not be interrupted, and secondly, the effective mode refractive index difference of 0.06 makes that the phase shifter only needs 12.915 um to achieve π phase shift at a central wavelength of 1550 nm, and thus the integration is greatly improved compared with the lithium niobate modulator with a size of several millimeters. In addition, in the phase change process, imaginary part k of the waveguide refractive index is always very small, so that the overall loss of the phase shifter does not change much.

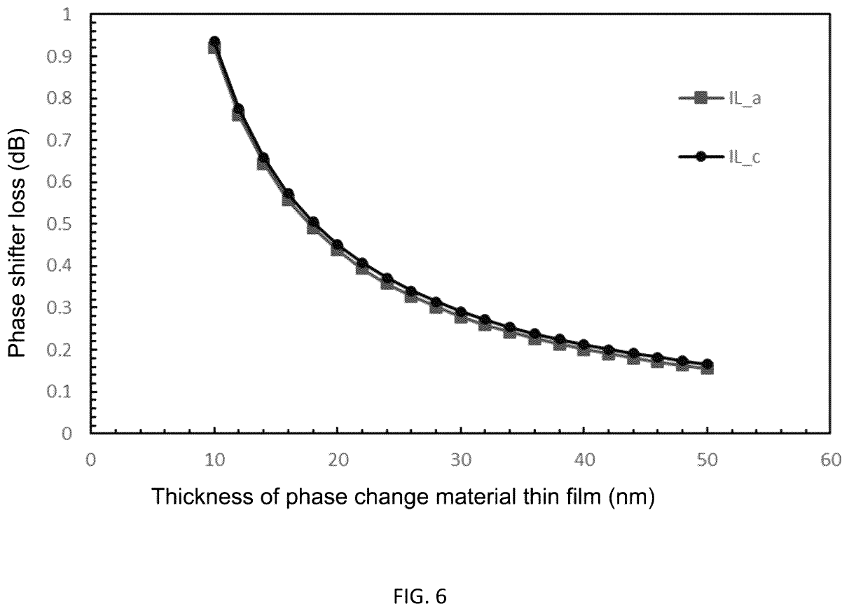

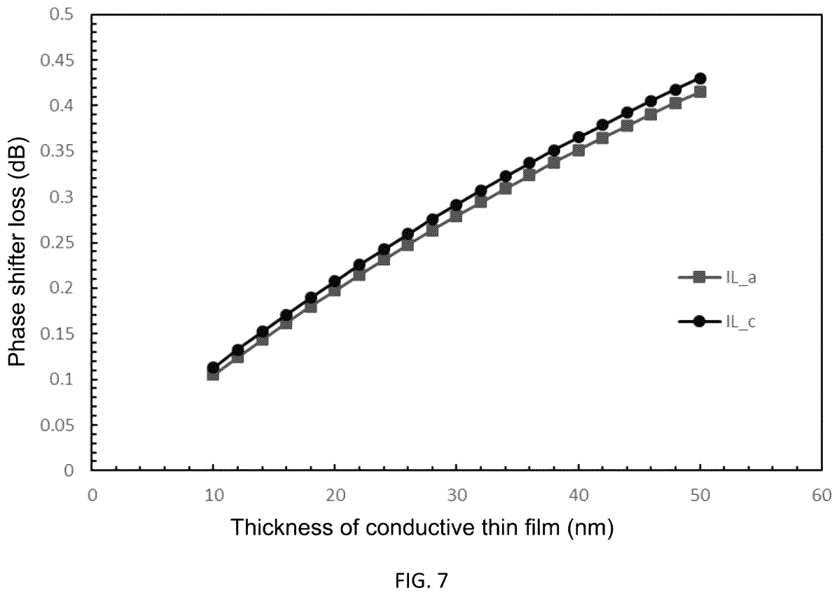

Referring to FIG. 6 and FIG. 7, FIG. 6 is a diagram of influence of thickness change of the phase change material thin film on loss of the optical phase shifter provided in an embodiment of the present disclosure; and FIG. 7 is a diagram of influence of thickness change of a conductive thin film on loss of the optical phase shifter provided in an embodiment of the present disclosure. Optionally, the phase change material thin films in FIG. 6 and FIG. 7 are Sb₂Se₃ thin films, and the conductive thin film is an indium tin oxide thin film.

Optionally, simulation results of influence of thickness change of the phase change material thin film 302 and thickness change of the conductive thin film 303 on the overall loss of the phase shifter are as shown in FIG. 6 and FIG. 7. In the present embodiment, the thickness of the phase change material thin film 302 and the thickness of the conductive thin film 303 are both selected to be 30 nm, and the corresponding loss of the phase shifter when the phase change material thin film 302 is in the amorphous state and the crystalline state is only 0.29 dB and 0.279 dB.

Exemplarily, the polarization control device based on silicon waveguide and phase change material provided in an embodiment of the present disclosure is a polarization control device on silicon substrate, and has at least the following beneficial effects:
(1) being capable of realizing the generation of any on-chip polarization state independent of the optical signal input; and
(2) being compatible with the conventional CMOS processing technology, having a simple and compact structure, further reducing the dimension of the devices by virtue of the high refractive index of the silicon waveguide and the high refractive index change of the phase change material thin film in the crystalline state-amorphous state, and being suitable for large-scale integration.

In all embodiments of the present disclosure, “large” and “small” are relative terms, “more” and “less” are relative terms, “upper” and “lower” are relative terms, and expressions of such relative terms are not repeated in the embodiments of the present disclosure.

It should be understood that reference to “in the present embodiment”, “in an embodiment of the present disclosure” or “as an optional embodiment” throughout the description means that particular features, structures or characteristics related to the embodiment are included in at least one embodiment of the present disclosure. Therefore, “in the present embodiment”, “in an embodiment of the present disclosure” or “as an optional embodiment” appearing throughout the description does not necessarily refer to the same embodiment. Besides, these specific features, structures or characteristics may be incorporated in one or more embodiments in any suitable manner. It should also be understood by a person skilled in the art that all the embodiments described in the description belong to optional embodiments, and acts and modules involved are not necessarily indispensable in the present disclosure.

In various embodiments of the present disclosure, it should be understood that the size of serial numbers of various processes in the above does not mean necessary execution order, and the execution order of various processes should be determined by its function and built-in logic, and should not limit the implementation process of the embodiments of the present disclosure in any way.

The above-mentioned are merely for specific embodiments of the present disclosure, but the scope of protection of the present disclosure is not limited thereto, and changes or substitutions easily conceivable by any skilled person familiar with the technical field within the technical scope disclosed in the present disclosure should fall within the scope of protection of the present disclosure. Therefore, the scope of protection of the present disclosure should be determined by the scope of protection of the claims.

### INDUSTRIAL APPLICABILITY

In the polarization control device disclosed in the embodiments of the present disclosure, the optical signal input from the input optical fiber is processed by the polarization rotation beam splitter, the first optical beam splitter, the first phase shifter, the second phase shifter, the second optical beam splitter, the third phase shifter, the fourth phase shifter, and the polarization rotation beam combiner in sequence, and the first phase shifter, the second phase shifter, the third phase shifter, and the fourth phase shifter are all optical phase shifters of the silicon waveguide and phase change material, so that modulation of any input-independent silicon-waveguide-based polarization state is realized, and any polarization state can be generated on premise of small dimension and low loss, wherein the optical phase shifters of the silicon waveguide and phase change material can greatly reduce the dimension of the polarization control device, which is conducive to large-scale integration. Therefore, the polarization control device based on the silicon waveguide and phase change material can realize the technical effect of generating input-independent arbitrarily polarized light.

The polarization control device based on silicon waveguide and phase change material provided in the embodiments of the present disclosure is a polarization control device on silicon substrate, and has at least the following beneficial effects: (1) being capable of realizing the generation of any on-chip polarization state independent of the optical signal input; and (2) being compatible with the conventional CMOS processing technology, having a simple and compact structure, further reducing the dimension of the devices by virtue of the high refractive index of the silicon waveguide and the high refractive index change of the phase change material thin film in the crystalline state-amorphous state, and being suitable for large-scale integration.

1. A polarization control device based on silicon waveguide and phase change material, comprising a polarization rotation beam splitter, an optical beam splitter component, a phase shifter component, and a polarization rotation beam combiner, wherein
the polarization rotation beam splitter comprises an adiabatic tapered silicon waveguide, an asymmetric directional coupler, a multi-mode interference mode filter, an upper output end mode transition cone, and a lower output end mode transition cone;
an input end of the polarization rotation beam splitter is connected to an input optical fiber;
the optical beam splitter component comprises a first optical beam splitter and a second optical beam splitter, and the phase shifter component comprises a first phase shifter, a second phase shifter, a third phase shifter, and a fourth phase shifter, wherein the first phase shifter, the second phase shifter, the third phase shifter, and the fourth phase shifter are all optical phase shifters of silicon waveguide and phase change material, an input end of the first optical beam splitter is connected to an output end of the polarization rotation beam splitter, a first output end of the first optical beam splitter is connected to the first phase shifter, and a second output end of the first optical beam splitter is connected to the second phase shifter;
an input end of the second optical beam splitter is connected to the first phase shifter and the second phase shifter, respectively, a first output end of the second optical beam splitter is connected to the third phase shifter, and a second output end of the second optical beam splitter is connected to the fourth phase shifter; and
an input end of the polarization rotation beam combiner is connected to the third phase shifter and the fourth phase shifter, respectively.

2. The polarization control device based on silicon waveguide and phase change material according to claim 1, wherein the input optical fiber transmits two beams of orthogonally polarized optical signals, the polarization rotation beam splitter converts the two beams of optical signals in the input optical fiber into two beams of optical signals in a preset mode, the two beams of optical signals in the preset mode are respectively transmitted to the input end of the first optical beam splitter, and the two beams of optical signals in the preset mode have the same intensity and the same phase.

3. The polarization control device based on silicon waveguide and phase change material according to claim 2, wherein the first optical beam splitter combines the two beams of optical signals in the preset mode, and outputs combined optical signals respectively from the first output end and the second output end of the first optical beam splitter according to an equally divided power.

4. The polarization control device based on silicon waveguide and phase change material according to claim 1, wherein the second optical beam splitter combines an optical signal transmitted by the first phase shifter and an optical signal transmitted by the second phase shifter, and outputs combined optical signals respectively from the first output end and the second output end of the second optical beam splitter according to an equally divided power.

5. The polarization control device based on silicon waveguide and phase change material according to claim 1, wherein the first optical beam splitter is a multi-mode interference coupler or a directional coupler, and the second optical beam splitter has the same structure as the first optical beam splitter.

6. The polarization control device based on silicon waveguide and phase change material according to claim 1, wherein each of the optical phase shifters has a silicon waveguide, a phase change material thin film with a width equal to that of the silicon waveguide, and a conductive thin film in sequence from bottom to top, an electrode is arranged at each of two sides of each of the optical phase shifters, and an electrical path is formed between the electrode and the conductive thin film.

7. The polarization control device based on silicon waveguide and phase change material according to claim 1, wherein the polarization rotation beam splitter is either a single integrated device or a cascading device, and the cascading device comprises a silicon-based polarization beam combiner and a silicon-based polarization rotator.

8. The polarization control device based on silicon waveguide and phase change material according to claim 7, wherein the polarization rotation beam combiner is either the single integrated device or the cascading device.

9. The polarization control device based on silicon waveguide and phase change material according to claim 8, wherein the polarization rotation beam combiner and the polarization rotation beam splitter are in a centrosymmetric structure.

10. The polarization control device based on silicon waveguide and phase change material according to claim 1, wherein the optical beam splitter component is a 2×2 optical beam splitter component.
